(19) United States
(12) Patent Application Publication
(10) Pub. No.: US 2026/0127510 A1
(43) Pub. Date: May 7, 2026

(54) LOCATION-BASED QUEUE MANAGEMENT FOR USER REQUESTS

(71) Applicant: priceline.com LLC, Norwalk, CT (US)

(72) Inventor: Kumaraguru Loganathan, Celina, TX (US)

(21) Appl. No.: 18/940,691

(22) Filed: Nov. 7, 2024

(51) Int. Cl. G06Q 10/02

(52) U.S. Cl. CPC G06Q 10/02

(57) ABSTRACT

As disclosed herein, a computer-implemented method for prioritizing a customer support request based on a location of the customer is disclosed. The computer-implemented method may include receiving, via a client device of a user associated with a booking made in a travel application, a request associated with the booking. The computer-implemented method may include determining a location of the client device. The computer-implemented method may include determining, based on the location of the client device, a priority level of the request. The computer-implemented method may include updating, based on the priority level of the request, a position of the request in a queue of an agent associated with the travel application. A system and a non-transitory computer-readable storage medium are also disclosed.

### BACKGROUND

### Field

The present disclosure generally relates to customer support technology. More particularly, the present disclosure relates to managing a priority of a customer support request based on a proximity of a customer to a location associated with a product obtained by the customer.

### Related Art

The travel industry has experienced unprecedented growth in recent years, driven by an increasing demand for travel experiences and a proliferation of digital booking platforms. As travel becomes more accessible, customer support has emerged as a critical differentiator for companies seeking to enhance customer loyalty and satisfaction.

The complexity and immediacy of travel-related issues present unique challenges for customer support teams. Customers often encounter a variety of issues related to travel bookings (e.g., flight cancelations, hotel check-in discrepancies, or rental car disagreements) that require immediate attention. However, traditional customer support frameworks frequently operate on a first-come, first-served basis, which may not effectively address the urgency of specific situations.

### SUMMARY

The subject disclosure provides for managing a priority level of a customer support request based on a location of a client device of a user relative to a location associated with a travel product booked by the user (e.g., lodging, means of transportation, destination activity). If the location of the client device is at or near the location associated with the travel product, then the priority level may be increased or escalated. If the location of the client device is neither at nor near the location associated with the travel product, then the priority level may be decreased or deescalated.

According to certain aspects of the present disclosure, a computer-implemented method for prioritizing a customer support request based on a location of a customer is disclosed. The computer-implemented method may include receiving, via a client device of a user associated with a booking made in a travel application, a request associated with the booking. The computer-implemented method may include determining a location of the client device. The computer-implemented method may include determining, based on the location of the client device, a priority level of the request. The computer-implemented method may include updating, based on the priority level of the request, a position of the request in a queue of an agent associated with the travel application.

According to another aspect of the present disclosure, a system is provided. The system may include one or more processors. The system may include a memory storing instructions that, when executed by the one or more processors, cause the system to perform operations. The operations may include receiving, via a client device of a user associated with a booking made in a travel application, a request associated with the booking. The operations may include determining a location of the client device. The operations may include determining, based on the location of the client device, a priority level of the request. The operations may include updating, based on the priority level of the request, a position of the request in a queue of an agent associated with the travel application.

According to yet other aspects of the present disclosure, a non-transitory computer-readable storage medium storing instructions encoded thereon that, when executed by a processor, cause the processor to perform operations is provided. The operations may include receiving, via a client device of a user associated with a booking of a travel product made in a travel application, a request associated with the booking. The operations may include determining a distance of a location of the client device from a location associated with the travel product is less than or equal to a predetermined threshold. The operations may include determining a time stamp of the request is within a time period before a start time associated with the travel product, after an end time associated with the travel product, or during the time between the start time and the end time. The operations may include increasing, based on the distance and the time stamp, a priority level of the request. The operations may include updating, based on the priority level of the request, a position of the request in a queue of an agent associated with the travel application.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments. In the drawings:

FIG. 1 illustrates an example environment suitable for prioritizing a customer support request based on a location of the customer, according to some embodiments;

FIG. 2 is a block diagram illustrating details of an example client device and an example server from the example environment of FIG. 1, according to some embodiments;

FIG. 3 includes a flowchart illustrating an example process for prioritizing a customer support request based on a location of the customer, according to some embodiments;

FIG. 4 includes a flowchart illustrating operations in a method for prioritizing a customer support request based on a location of the customer, according to some embodiments; and

FIG. 5 is a block diagram illustrating an exemplary computer system with which client devices, and the processes and methods in FIGS. 3 and 4, may be implemented, according to some embodiments.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below is intended as a description of various implementations and is not intended to represent the only implementations in which the subject technology may be practiced. As those skilled in the art would realize, the described implementations may be modified in various different ways, all without departing from the scope of the present disclosure. Accordingly, the drawings and description are to be regarded as illustrative in nature and not restrictive. Those skilled in the art may realize other elements that, although not specifically described herein, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

### General Overview

The travel industry has experienced unprecedented growth in recent years, driven by an increasing demand for travel experiences and a proliferation of digital booking platforms. As travel becomes more accessible, customer support has emerged as a critical differentiator for companies seeking to enhance customer loyalty and satisfaction.

The complexity and immediacy of travel-related issues present unique challenges for customer support teams. Customers often encounter a variety of issues related to travel bookings (e.g., flight cancelations, hotel check-in discrepancies, or rental car disagreements) that require immediate attention. However, traditional customer support frameworks frequently operate on a first-come, first-served basis, which may not effectively address the urgency of specific situations.

A critical factor influencing the urgency of customer support requests is the geographic proximity of a customer to a location of a travel product booked by or for the customer. For example, a customer experiencing a problem with a hotel reservation while already at the hotel may require immediate assistance to avoid disruptions to travel plans; however, a customer inquiring about a hotel reservation scheduled for several weeks later may have a lower urgency level and may afford to wait for a customer support response. Current systems often fail to consider such geographical context when prioritizing support requests. As a result, urgent cases may be delayed, leading to customer dissatisfaction, increased customer anxiety, and potential loss of business. Moreover, customer support agents may become overwhelmed by non-urgent requests, detracting from their ability to address critical issues promptly.

As disclosed herein, novel systems and methods represent a significant advancement in the field of customer support technology by providing for prioritizing customer support requests based on a relative location of a customer and a product (e.g., a travel product) the customer has reserved. By leveraging location data (e.g., Global Positioning System (GPS) coordinates, distance from a product), a priority of a customer support request may be determined, and higher priority requests may be identified and addressed more efficiently. The disclosed systems and methods may allow for enhanced operational efficiency, may improve response times for urgent requests, and may ultimately elevate the customer experience.

According to an exemplary embodiment, a user may create a user profile for a travel application. The user profile may include contact information related to the user or to an individual associated with the user (e.g., a telephone number of the user, an email address of a spouse of the user). Under the user profile, a user may book a travel product (e.g., lodging, means of transportation, destination activity). The booking may include contact information related to the user or to an individual associated with the booking (e.g., a telephone number of the user, an email address of a spouse traveling with or without the user). Using a client device (e.g., a mobile phone) associated with the contact information (e.g., telephone number, email address, user profile handle), a user or an associated individual may contact a customer support entity associated with the travel application (e.g., via phone call, text message, email, conversational user interface) to initiate a customer support request related to the travel product booked by or for the user or an associated individual. By way of non-limiting examples, a customer support request may include a request for information about a booking, a request to modify a travel itinerary, or a request to cancel a booking. Based on the contact information, a user profile may be identified. Based on the user profile, a booking for a travel product may be identified.

Based on the location of the client device used to initiate a customer support request relative to a location associated with the travel product (e.g., a departure airport for an airline flight, a rental center for a car), an initial or a subsequent priority level may be determined for the request. If the location of the client device is at or, based on a distance threshold, near the location associated with the travel product, then the priority level of the request may be increased or escalated. If the location of the client device is neither at nor, based on a distance threshold, near the location associated with the travel product, then the priority level of the request may be decreased or deescalated. Based on the priority level of the request, the request may be positioned in a queue of a customer support agent associated with the travel application. A high-priority request may be positioned closer to the front of the queue or ahead of a low-priority request. A low-priority request may be positioned closer to the end of the queue or after a high-priority request, or the low-priority request may be routed to an interactive voice response (IVR) system.

In some embodiments, at least one artificial intelligence (AI) model (e.g., machine learning (ML) model) may be configured to determine a priority of a customer service request based on at least a location of a client device used to initiate the request relative to a location associated with a travel product.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments may be practiced without these specific details. In other instances, well known structures and devices are shown in block diagram form in order to facilitate a description thereof. The intention is to cover all modifications, equivalents, and alternatives consistent with the claimed subject matter.

### Example System Architecture

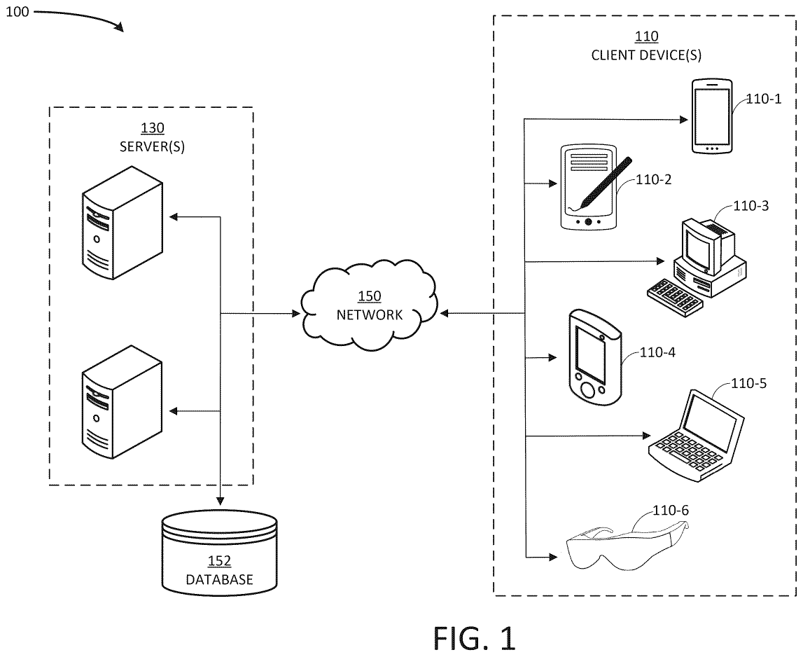

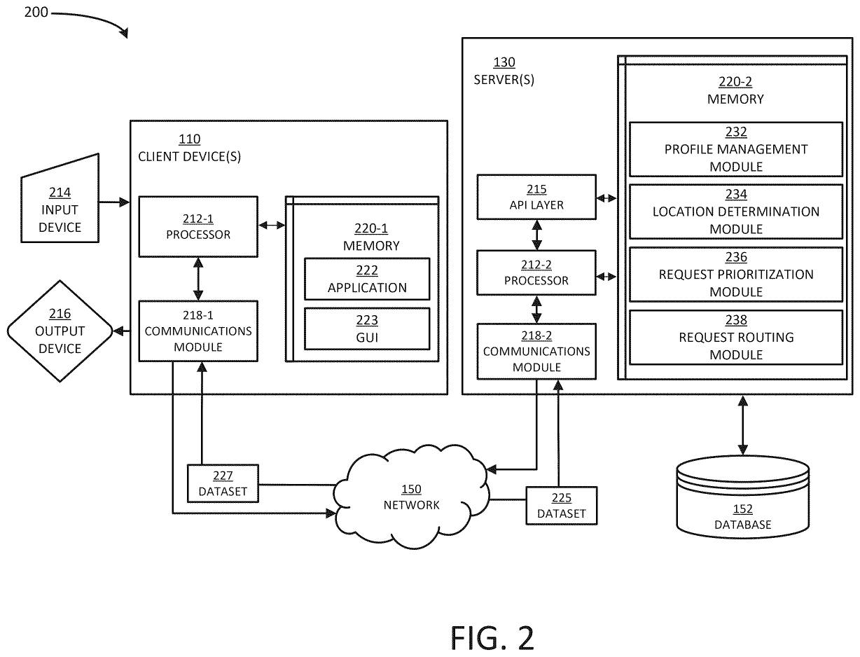

FIG. 1 illustrates an example environment suitable for prioritizing a customer support request based on a location of the customer, according to some embodiments. Environment 100 may include server(s) 130 communicatively coupled with client device(s) 110 and database 152 over a network 150. One of the server(s) 130 may be configured to host a memory including instructions which, when executed by a processor, cause server(s) 130 to perform at least some of the steps or operations in methods or processes as disclosed herein. In some embodiments, the processor may be configured to control a graphical user interface (GUI) for the user of one of client device(s) 110 accessing a profile management module (e.g., profile management module 232, FIG. 2), a location determination module (e.g., location determination module 234, FIG. 2), a request prioritization module (e.g., request prioritization module 236, FIG. 2), or a request routing module (e.g., request routing module 238, FIG. 2) with an application (e.g., application 222, FIG. 2). Accordingly, the processor may include a dashboard tool, configured to display components and graphic results to the user via a GUI (e.g., GUI 223, FIG. 2). For purposes of load balancing, multiple servers of server(s) 130 may host memories including instructions to one or more processors, and multiple servers of server(s) 130 may host a history log and database 152 including multiple training archives for the profile management module, the location determination module, the request prioritization module, or the request routing module. Moreover, in some embodiments, multiple users of client device(s) 110 may access the same profile management module, location determination module, request prioritization module, or request routing module. In some embodiments, a single user with a single client device (e.g., one of client device(s) 110) may provide images and data (e.g., text) to train one or more machine learning models running in parallel in one or more server(s) 130. Accordingly, client device(s) 110 and server(s) 130 may communicate with each other via network 150 and resources located therein, such as data in database 152.

Server(s) 130 may include any device having an appropriate processor, memory, and communications capability for the profile management module, the location determination module, the request prioritization module, or the request routing module. Any of the profile management module, the location determination module, the request prioritization module, or the request routing module may be accessible by client device(s) 110 over network 150.

Client device(s) 110 may include any one of laptop computer 110-5, desktop computer 110-3, or a mobile device such as smartphone 110-1, palm device 110-4, or tablet device 110-2. In some embodiments, client device(s) 110 may include headset or other wearable device 110-6 (e.g., a virtual reality headset, augmented reality headset, or smart glass), such that at least one participant may be running an immersive reality application installed therein.

Network 150 may include, for example, any one or more of a local area network (LAN), a wide area network (WAN), the Internet, and the like. Further, network 150 may include, but is not limited to, any one or more of the following network topologies, including a bus network, a star network, a ring network, a mesh network, a star-bus network, tree or hierarchical network, and the like.

A user may own or operate client device(s) 110 that may include smartphone device 110-1 (e.g., an IPHONE® device, an ANDROID® device, a BLACKBERRY® device, or any other mobile computing device conforming to a smartphone form). Smartphone device 110-1 may be a cellular device capable of connecting to network 150 via a cell system using cellular signals. In some embodiments and in some cases, smartphone device 110-1 may additionally or alternatively use Wi-Fi or other networking technologies to connect to network 150. Smartphone device 110-1 may execute a client, Web browser, or other local application to access server(s) 130.

A user may own or operate client device(s) 110 that may include tablet device 110-2 (e.g., an IPAD® tablet device, an ANDROID® tablet device, a KINDLE FIRE® tablet device, or any other mobile computing device conforming to a tablet form). Tablet device 110-2 may be a Wi-Fi device capable of connecting to network 150 via a Wi-Fi access point using Wi-Fi signals. In some embodiments and in some cases, tablet device 110-2 may additionally or alternatively use cellular or other networking technologies to connect to network 150. Tablet device 110-2 may execute a client, Web browser, or other local application to access server(s) 130.

The user may own or operate client device(s) 110 that may include personal computer device 110-5 (e.g., a MAC OS® device, WINDOWS® device, LINUX® device, or other computer device running another operating system). Personal computer device 110-5 may be an Ethernet device capable of connecting to network 150 via an Ethernet connection. In some embodiments and in some cases, personal computer device 110-5 may additionally or alternatively use cellular, Wi-Fi, or other networking technologies to connect to network 150. Personal computer device 110-5 may execute a client, Web browser, or other local application to access server(s) 130.

FIG. 2 is a block diagram 200 illustrating details of example client device(s) 110 and example server(s) 130 from the example environment of FIG. 1, according to some embodiments. Client device(s) 110 and server(s) 130 may be communicatively coupled over network 150 via respective communications modules 218-1 and 218-2 (hereinafter, collectively referred to as “communications modules 218”). Communications modules 218 may be configured to interface with network 150 to send and receive information, such as requests, responses, messages, and commands to other devices on the network in the form of datasets 225 and 227. Communications modules 218 may be, for example, modems or Ethernet cards, and may include radio hardware and software for wireless communications (e.g., via electromagnetic radiation, such as radiofrequency (RF), near field communications (NFC), Wi-Fi, or Bluetooth radio technology). Client device(s) 110 may be coupled with input device 214 and with output device 216. Input device 214 may include a keyboard, a mouse, a pointer, a touchscreen, a microphone, a joystick, a virtual joystick, and the like. In some embodiments, input device 214 may include cameras, microphones, and sensors, such as touch sensors, acoustic sensors, inertial motion units (IMUs), and other sensors configured to provide input data to an AR/VR headset. For example, in some embodiments, input device 214 may include an eye-tracking device to detect the position of a pupil of a user in an AR/VR headset. Likewise, output device 216 may include a display and a speaker with which the customer may retrieve results from client device(s) 110. Client device(s) 110 may also include a processor 212-1, configured to execute instructions stored in a memory 220-1, and to cause client device(s) 110 to perform at least some of the steps in methods or processes consistent with the present disclosure. Memory 220-1 may further include an application 222 and a graphical user interface (GUI) 223, configured to run in client device(s) 110 and couple with input device 214 and output device 216. Application 222 may be downloaded by the user from server(s) 130 and may be hosted by server(s) 130. In some embodiments, client device(s) 110 may be an AR/VR headset and application 222 may be an immersive reality application. In some embodiments, client device(s) 110 may be a mobile phone used to collect a video or picture and upload to server(s) 130 using a video or image collection application (e.g., application 222), to store in database 152. In some embodiments, application 222 may run on any operating system (OS) installed in client device(s) 110. In some embodiments, application 222 may run out of a Web browser, installed in client device(s) 110.

Dataset 227 may include multiple messages and multimedia files. A user of client device(s) 110 may store at least some of the messages and data content in dataset 227 in memory 220-1. In some embodiments, a participant may upload, with client device(s) 110, dataset 225 onto server(s) 130, as part of a messaging interaction (or conversation, or “chat”). Accordingly, dataset 225 may include a message from the participant, or a multimedia file that the participant wishes to share in a conversation.

A database 152 may store data and files associated with application 222 (e.g., one or more of datasets 225 and 227).

Server(s) 130 may include application programming interface (API) layer 215, which may control application 222 in each of client device(s) 110. Server(s) 130 may also include a memory 220-2 storing instructions which, when executed by processor 212-2, cause server(s) 130 to perform at least partially one or more operations in methods consistent with the present disclosure.

Processors 212-1 and 212-2 and memories 220-1 and 220-2 will be collectively referred to, hereinafter, as “processors 212” and “memories 220,” respectively.

Processors 212 may be configured to execute instructions stored in memories 220. In some embodiments, memory 220-2 may include profile management module 232, location determination module 234, request prioritization module 236, or request routing module 238. Profile management module 232, location determination module 234, request prioritization module 236, or request routing module 238 may share or provide features and resources to GUI 223. A user may access profile management module 232, location determination module 234, request prioritization module 236, or request routing module 238 through application 222, installed in a memory 220-1 of client device(s) 110. Accordingly, application 222, including GUI 223, may be installed by server(s) 130 and perform scripts and other routines provided by server(s) 130 through any one of multiple tools. Execution of application 222 may be controlled by processor 212-1.

Profile management module 232 may be configured for creation, customization, and management of user profiles for an application (e.g., a travel application). Profile management module 232 may enable a user to register an account with the application by providing personal details, such as a name of the user, an email address of the user, or an account password. After registration, a user may complete a user profile by adding information such as travel preferences, language preferences, payment methods, or names or contact information for individuals associated with the user (e.g., relatives, travel companions, emergency contacts). In some embodiments, one or more profiles may be created for a single account. When creating a user profile or when accessing the application, a user may be prompted to grant permission for location services. Location services may enable the application to route customer support requests or to provide personalized recommendations based on a current, recent, or a frequently visited location of the user. A user may be enabled to manage location permissions in user profile settings. For example, a user may be enabled to toggle between precise or approximate location access, or to disable location access entirely. Such flexibility may ensure compliance with privacy preferences. A user may update an aspect of a user profile (e.g., personal details, travel preferences) at any time (e.g., from a profile management dashboard of the application).

While logged into an application under the user profile, a user may purchase, reserve, or otherwise obtain a product offered by an entity associated with the application. For example, a user may log into a travel application using registered credentials or biometric login. Accessing the application under the user profile may ensure that bookings of travel products may be tailored to a preference of a user or saved under the account of a user or profile of a user. By way of non-limiting examples, a travel product may include a lodging (e.g., hotel, resort, motel, hostel, guest house, holiday cottage, apartment, cabin, cruise ship, or bed and breakfast); a means of transportation (e.g., airplane, car, train, cruise ship, or bicycle); a destination activity (e.g., a shoreside excursion, sporting event, or local tour); an amenity associated with a lodging, means of transportation, or destination activity (e.g., a spa or laundry service of a hotel); or a travel package including a lodging, a means of transportation, a destination activity, or an amenity associated with a lodging, means of transportation, or destination activity. While booking a travel product or after booking the travel product, a user may be enabled to add personal details (e.g., names or contact information) for individuals associated with the booking or the travel product. For example, if a user books a travel product as a gift for a parent, then the user may provide the name or contact information of the user or of the parent. The contact information (e.g., telephone number, email address, user profile handle) may be used to identify a user profile or a booking made under a user profile when a customer support request is initiated.

Location determination module 234 may be configured for assessing a location of a customer relative to a location associated with a travel product. The location of the customer may be assessed by determining a location of a client device used to initiate a customer support request. For example, a user may place a call to a customer support phone number using a mobile phone, wherein a phone number of the mobile phone may be associated with an account or a profile of the user. With user permissions granted for location services, location determination module 234 may implement various geolocation technologies to accurately determine a location of a client device of a user associated with a user account or a booking of a travel product, or to calculate the distance of the client device from the travel product. Example methods for determining a location of a client device or a location associated with a travel product may include Global Positioning System (GPS) technology, Wi-Fi positioning system (WPS) technology, cellular tower triangulation, IP address geolocation, or Bluetooth beacons. A location of a client device or a location associated with a travel product may be updated in real time. A location associated with a travel product may be static (e.g., a location of an airport or a hotel) or dynamic (e.g., a location of a rideshare or carshare vehicle, or a location of a meeting place for a hiking excursion). A location associated with a travel product (e.g., a departure airport for an airline flight) may be stored in a database for access and comparison to a location of a client device. In some embodiments, location determination module 234 may implement geospatial algorithms (e.g., Haversine formula, Euclidean distance) to compute a distance between a location of the client device and a location of the travel product. Geospatial algorithms may yield straight-line distances or estimated travel times based on available transportation methods.

Request prioritization module 236 may be configured to determine a priority level of a customer support request based on a distance of a location of a client device used to initiate the request (e.g., a mobile phone) from a location of a product (e.g., a travel product) purchased, reserved, or otherwise obtained by or for a customer. A priority level may be characterized qualitatively (e.g., based on levels, such as high, low) or quantitatively (e.g., based on a numeric scale, wherein a higher figure may correspond to a high priority and a lower figure may correspond to a low priority).

If request prioritization module 236 determines a distance of the client device from a product is greater than a predetermined threshold (e.g., five kilometers), then request prioritization module 236 may assign a low priority level to the request or may decrease a previously determined priority level of the request. If request prioritization module 236 determines a distance of the client device from the product is less than or equal to a predetermined threshold (e.g., five kilometers), then request prioritization module 236 may assign a high priority level to the request or may increase a previously determined priority level of the request. In some embodiments, request prioritization module 236 may dynamically update the predetermined threshold based on factors such as time of day, day of the week, weather conditions, agent availability, or customer loyalty status.

Other contextual factors, such as time sensitivity, may be considered when determining a priority level. Time sensitivity may include a start time or an end time associated with a travel product. For example, a start time associated with a booking of a rental car may include a pick-up time for the rental car, and an end time associated with the booking of the rental car may include a drop-off time for the rental car. For another example, a start time associated with a booking of a hotel room may include a check-in time for the hotel room, and an end time associated with the booking of the hotel room may include a check-out time for the hotel room. For a further example, a start time associated with a booking of an airline flight may include a check-in time or a departure time for the airline flight, and an end time associated with the booking of the airline flight may include a landing time for the airline flight.

If request prioritization module 236 determines a time stamp of the request is outside a predetermined time period (e.g., twenty-four hours) before a start time associated with a travel product or after an end time associated with the travel product, then request prioritization module 236 may assign a low priority level to the request or may decrease a previously determined priority level of the request. If request prioritization module 236 determines a time stamp of a request is within a predetermined time period (e.g., twenty-four hours) before a start time associated with a travel product, after an end time associated with the travel product, or during the time between the start time and the end time, then request prioritization module 236 may assign a high priority level to the request or may increase a previously determined priority level of the request. In some embodiments, request prioritization module 236 may dynamically update the predetermined time period based on factors such as time of day, day of the week, weather conditions, agent availability, or customer loyalty status.

In some embodiments, request prioritization module 236 may be configured to leverage artificial intelligence (AI) techniques (e.g., machine learning (ML) techniques) to determine a priority level of a customer support request based on a distance of a location of a client device used to initiate the request (e.g., a mobile phone) from a location of a product (e.g., a travel product) purchased, reserved, or otherwise obtained by or for a customer. Request prioritization module 236 may access one or more artificial intelligence (AI) models (e.g., machine learning (ML) models) stored in database 152. Database 152 may include training archives and other data files that may be used by request prioritization module 236 in the training of an AI model. Moreover, in some embodiments, at least one or more training archives or AI models may be stored in any one of memories 220, and a user may access the at least one or more training archives or AI models through application 222.

Request prioritization module 236 may include algorithms trained for the specific purposes of the modules included therein. The algorithms may include machine learning or artificial intelligence (AI) algorithms making use of any linear or non-linear algorithm, such as a neural network algorithm or a multivariate regression algorithm. In some embodiments, an ML model may include a neural network (NN), a convolutional neural network (CNN), a generative adversarial neural network (GAN), a deep reinforcement learning (DRL) algorithm, a deep recurrent neural network (DRNN), or a classic ML algorithm such as random forest, k-nearest neighbor (KNN) algorithm, k-means clustering algorithms, or any combination thereof. More generally, an ML model may include any ML model involving a training step and an optimization step. In some embodiments, database 152 may include a training archive to modify coefficients according to a desired outcome of an ML model. Accordingly, in some embodiments, request prioritization module 236 may be configured to access training database 152 to retrieve documents and archives as inputs for an ML model. In some embodiments, request prioritization module 236, the tools contained therein, and at least part of database 152 may be hosted in a different server that is accessible by server(s) 130 or client device(s) 110.

Request prioritization module 236 may collect data including customer location (e.g., via GPS data obtained by a GPS sensor of a client device of a customer), request type, booking details, or urgency indicators (e.g., last-minute requests). Request prioritization module 236 may maintain a database with geographical coordinates of travel products (e.g., hotels, tours, attractions), along with details such as booking status, cancelation policies, or availability. Request prioritization module 236 may conduct feature engineering by computing a distance between a customer location and a travel product using geographic distance formulas (e.g., Haversine). Additional features may include time sensitivity (e.g., dates of travel), customer history (e.g., previous bookings, loyalty status), or request complexity (e.g., changes to booking, cancelations of bookings). The data may be split into training datasets and testing datasets to evaluate model performance and adjust parameters accordingly. One or more AI models may be trained using training data to determine a relationship between a distance of a customer from a travel product at the time a customer support request is made and a priority level of the request.

Request prioritization module 236 may include one or more AI algorithms suitable for outputting a priority score based on input features, indicating how urgently a customer support request should be addressed. In some embodiments, a score may be categorized into levels, which may be characterized qualitatively (e.g., based on levels, such as high, low) or quantitatively (e.g., based on a numeric scale, wherein a higher figure may correspond to a high priority and a lower figure may correspond to a low priority). The AI model may be implemented in a real-time environment, wherein incoming support requests may be processed immediately. Prioritization results may be integrated into a customer support queuing system, wherein high-priority requests may be flagged for immediate attention, allowing live (i.e., human) customer support agents to focus on the most urgent cases. Low-priority requests may be positioned after high-priority requests in a queue of a live (i.e., human) customer support agent or routed to an interactive voice response (IVR) system.

Request routing module 238 may be configured for directing, based on a priority level of a customer support request, the customer service request to a live (i.e., human) agent, to a position in a queue of a live agent, or to an automated system (e.g., an interactive voice response (IVR) system). In some embodiments, a live agent may be a customer support representative associated with a travel application or a travel platform used to book a travel product. Request routing module 238 may ensure a customer who is located closer to a travel product booked by the customer receives prioritized support, enhancing responsiveness and customer satisfaction. A request may be assigned, routed to, or placed in a queue position based on a priority level of the request. For example, a high-priority request may be assigned, routed to, or placed in a queue position at or near a front of a queue of a live agent, or ahead of a low-priority request. For another example, a low-priority request may be assigned, routed to, or placed in a queue position at or near a back of a queue of a live agent, or after a high-priority request.

Request routing module 238 may process incoming support requests in real time, adjusting queue positions dynamically as new requests are received or as a location of a customer or a location of a travel product changes. Request routing module 238 may alert a live agent (e.g., via audio, visual, or haptic feedback) about a high-priority request in a queue of the live agent, enabling the live agent to respond promptly. An alert may include a visual indicator in a dashboard of a travel application accessed by the live agent.

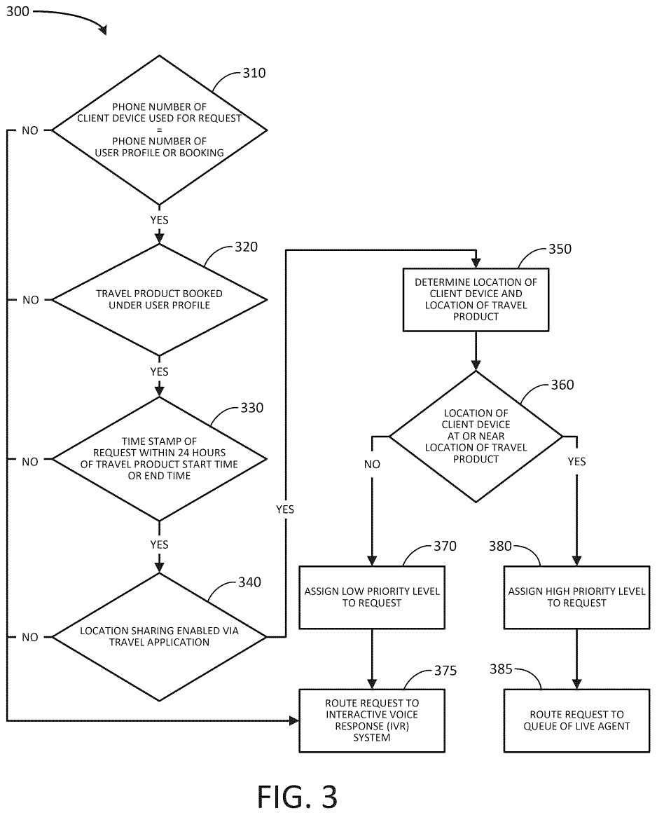

FIG. 3 includes a flowchart illustrating an example process 300 for prioritizing a customer support request based on a location of the customer, according to some embodiments. In some embodiments, steps as disclosed herein may include one or more steps in process 300 performed by a processor circuit executing instructions stored in a memory circuit, in a client device, a remote server or a database, communicatively coupled through a network (e.g., processors 212, memories 220, client device(s) 110, server(s) 130, database 152, and network 150). In some embodiments, one or more of the steps in process 300 may be performed by a profile management module, a location determination module, a request prioritization module, or a request routing module (e.g., profile management module 232, location determination module 234, request prioritization module 236, or request routing module 238). In some embodiments, processes consistent with the present disclosure may include at least one or more steps as in process 300 performed in a different order, simultaneously, quasi-simultaneously, or overlapping in time.

Step 310 includes determining whether a phone number of a client device used for making a customer support request matches a phone number associated with a user profile of a travel application or with a booking made under the user profile of the travel application. In some embodiments, a phone number associated with a user profile may be the same as a phone number associated with a booking. For example, an individual may create a user profile and provide a phone number of the individual for the user profile. The individual may, under the user profile of the individual, book a hotel stay for the individual, and the individual may provide a phone number of the individual for the booking. The individual may, using a mobile phone associated with the phone number for the booking, initiate a customer support request. In some embodiments, a phone number associated with a user profile may be different from a phone number associated with a booking. For example, a parent may create a user profile and may provide a phone number of the parent for the user profile. The parent may, under the user profile of the parent, book an airline flight for a child of the parent, and the parent may provide a phone number of the child for the booking. The child may, using a mobile phone associated with the phone number for the booking, initiate a customer support request. If the phone number of the client device used for making the customer support request does not match a phone number associated with a user profile or a booking (NO at step 310), then process 300 may proceed to step 375. If the phone number of the client device used for making the customer support request does match a phone number associated with a user profile or a booking (YES at step 310), then process 300 may proceed to step 320.

In some embodiments, step 310 may include assigning an initial priority level to a customer support request. For example, an initial priority level may be low if the phone number of the client device used for making the customer support request does not match a phone number associated with a user profile or with a booking. For another example, an initial priority level may be high if the phone number of the client device used for making the customer support request does match a phone number associated with a user profile or with a booking.

Step 320 includes identifying one or more travel products booked under the user profile of the travel application. If a travel product cannot be identified (NO at step 320), then process 300 may proceed to step 375. If a travel product can be identified (YES at step 320), then process 300 may proceed to step 330.

Step 330 includes determining whether a time stamp of the customer support request is within a predetermined time period (e.g., twenty-four hours) of a start time or an end time associated with the travel product. In some embodiments, the predetermined time period may be dynamically updated based on factors such as time of day, day of the week, weather conditions, agent availability, or customer loyalty status.

If the time stamp of the customer support request is outside of the predetermined time period (NO at step 330), then process 300 may proceed to step 375. If the time stamp of the customer support request is within the predetermined time period (YES at step 330), then process 300 may proceed to step 340.

Step 340 includes determining whether location sharing has been enabled via the travel application. If location sharing has not been enabled (NO at step 340), then process 300 may proceed to step 375. In some embodiments, if location sharing has not been previously enabled, then a user may be prompted (e.g., via push notification or text message of the travel application) to enable location sharing. If location sharing has been enabled (YES at step 340), then process 300 may proceed to step 350.

Step 350 includes determining a location of the client device used for making the customer support request and a location associated with the travel product. Various geolocation technologies may be implemented to determine a location of the client device or the travel product. Example methods for determining a location of the client device or the location associated with a travel product may include Global Positioning System (GPS) technology, Wi-Fi positioning system (WPS) technology, cellular tower triangulation, IP address geolocation, or Bluetooth beacons. A location of a client device or a location associated with a travel product may be updated in real time. A location associated with a travel product may be static (e.g., a location of an airport or a hotel) or dynamic (e.g., a location of a rideshare or carshare vehicle, or a location of a meeting place for a hiking excursion).

Step 360 includes determining whether a location of the client device used for making the customer support request is at or near a location associated with the travel product. In some embodiments, a location associated with a travel product (e.g., a departure airport for an airline flight) may be stored in a database for access and comparison to a location of a client device. In some embodiments, geospatial algorithms (e.g., Haversine formula, Euclidean distance) may be implemented to compute a distance between a location of the client device and a location associated with the travel product. Geospatial algorithms may yield straight-line distances or estimated travel times based on available transportation methods. If the location of the client device is neither at nor near the location associated with the travel product (NO at step 360), then process 300 may proceed to step 370. If the location of the client device is at or near the location associated with the travel product (YES at step 360), then process 300 may proceed to step 380.

Step 370 includes assigning a low priority level to the customer support request. A low priority may be characterized qualitatively (e.g., “low,” “minor,” “non-urgent”) or quantitatively (e.g., based on a numeric scale, such as one to ten, wherein a lower figure (e.g., 1, 2, or 3) may correspond to a low priority level). In some embodiments, step 370 includes routing a customer support request to a queue of a live agent. In some embodiments, a low-priority request may be routed to or placed in a queue including only low-priority requests. A position of the low-priority request in the low-priority queue may be based on a priority level of the low-priority request relative to a priority level of other low-priority requests. For example, if priority level is assigned according to a numeric scale with lower numeric figures indicating low priority, then a low-priority request with a priority level of two may be placed behind a low-priority request with a priority level of three and ahead of a low-priority request with a priority level of one. In some embodiments, a low-priority request may be routed to or placed in a queue including high-priority and low-priority requests. A position of the low-priority request in a mixed-priority queue may be based on a priority level of the low-priority request relative to a priority level of other requests. For example, if priority level is assigned according to a numeric scale with greater numeric figures indicating high priority and lower numeric figures indicating low priority, then a low-priority request with a priority level of two may be placed behind a high-priority request with a priority level of ten and ahead of a low-priority request with a priority level of one.

Step 375 includes routing a customer support request to an interactive voice response (IVR) system. In some embodiments, the IVR system may provide fully automated assistance, including pre-recorded or text-to-speech messages, menu options (e.g., “Press 1 for hotel reservations), voice recognition, or self-service (e.g., a user may book a hotel room, check an airline flight status, or cancel a reservation). If the IVR system cannot handle a request, then the IVR system may route the request to a live customer support agent based on information provided by a user.

Step 380 includes assigning a high priority level to the customer support request. A high priority may be characterized qualitatively (e.g., “high,” “major,” “urgent”) or quantitatively (e.g., based on a numeric scale, such as one to ten, wherein a higher figure (e.g., 8, 9, or 10) may correspond to a high priority level).

Step 385 includes routing a customer support request to a queue of a live agent. In some embodiments, a high-priority request may be routed to or placed in a queue including only high-priority requests. A position of the high-priority request in the high-priority queue may be based on a priority level of the high-priority request relative to a priority level of other high-priority requests. For example, if priority level is assigned according to a numeric scale with greater numeric figures indicating higher priority, then a high-priority request with a priority level of nine may be placed behind a high-priority request with a priority level of ten and ahead of a high-priority request with a priority level of eight. In some embodiments, a high-priority request may be routed to or placed in a queue including high-priority and low-priority requests. A position of the high-priority request in a mixed-priority queue may be based on a priority level of the high-priority request relative to a priority level of other requests. For example, if priority level is assigned according to a numeric scale with greater numeric figures indicating higher priority and lower numeric figures indicating lower priority, then a high-priority request with a priority level of nine may be placed behind a high-priority request with a priority level of ten and ahead of a low-priority request with a priority level of two.

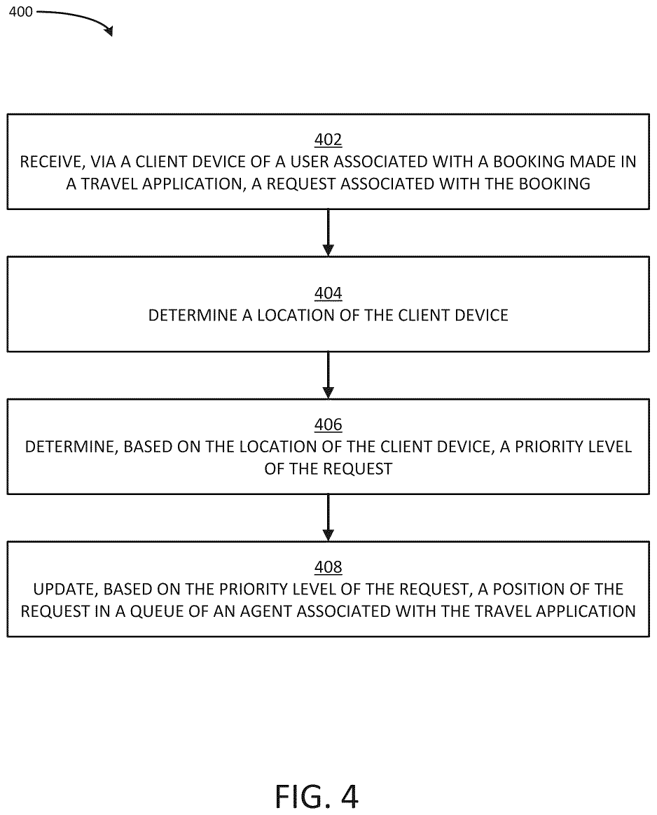

FIG. 4 includes a flowchart illustrating operations in a method 400 for prioritizing a customer support request based on a location of the customer, according to some embodiments. In some embodiments, processes as disclosed herein may include one or more operations in method 400 performed by a processor circuit executing instructions stored in a memory circuit, in a client device, a remote server or a database, communicatively coupled through a network (e.g., processors 212, memories 220, client device(s) 110, server(s) 130, database 152, and network 150). In some embodiments, one or more of the operations in method 400 may be performed by a profile management module, a location determination module, a request prioritization module, or a request routing module (e.g., profile management module 232, location determination module 234, request prioritization module 236, or request routing module 238). In some embodiments, methods consistent with the present disclosure may include at least one or more operations as in method 400 performed in a different order, simultaneously, quasi-simultaneously, or overlapping in time.

Operation 402 may include receiving, via a client device of a user associated with a booking made in a travel application, a request associated with the booking. In some embodiments, operation 402 may include identifying a user profile associated with at least one of an attribute of the request and an attribute of the client device. In further aspects of the embodiments, operation 402 may include identifying, based on the user profile, the booking. In some aspects of the embodiments, the attribute may include a telephone number. In some embodiments, the booking may include a booking of a travel product. In some aspects of the embodiments, the travel product may include at least one of a lodging, a means of transportation, and a destination activity.

Operation 404 may include determining a location of a client device. In some embodiments, determining the location of the client device may include determining a distance of the client device from a location associated with a travel product of the booking.

Operation 406 may include determining, based on a location of a client device, a priority level of a request. In some embodiments, determining the priority level of the request may include determining a distance of a location of the client device from a location associated with the travel product is greater than a predetermined threshold. In some aspects of the embodiments, determining the priority level of the request may include decreasing, based on determining the distance is greater than the predetermined threshold, the priority level of the request. In some embodiments, determining the priority level of the request may include determining a distance of a location of the client device from the location associated with the travel product is less than or equal to a predetermined threshold. In some aspects of the embodiments, determining the priority level of the request may include increasing, based on determining the distance is less than or equal to the predetermined threshold, the priority level of the request. In some embodiments, determining the priority level of the request may include determining a time stamp of the request is outside a time period before a start time associated with a travel product of the booking or after an end time associated with the travel product. In some aspects of the embodiments, determining the priority level of the request may include decreasing, based on determining the time stamp of the request is outside the time period, the priority level of the request. In some embodiments, determining the priority level of the request may include determining a time stamp of the request is within a time period before a start time associated with a travel product of the booking, after an end time associated with the travel product, or during the time between the start time and the end time. In some aspects of the embodiments, determining the priority level of the request may include increasing, based on determining the time stamp of the request is within the time period, the priority level of the request.

Operation 408 may include updating, based on a priority level of a request, a position of the request in a queue of an agent associated with the travel application. In some embodiments, the agent may include a live (i.e., human) agent.

### Hardware Overview

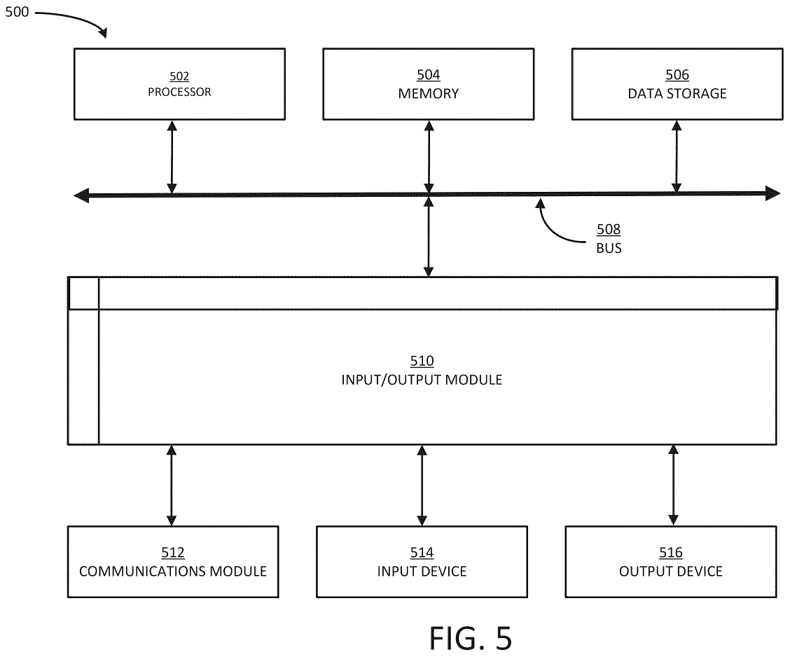

FIG. 5 is a block diagram illustrating an exemplary computer system with which client devices, and the processes and methods in FIGS. 3 and 4, may be implemented, according to some embodiments. In certain aspects, the computer system 500 may be implemented using hardware or a combination of software and hardware, either in a dedicated server, or integrated into another entity, or distributed across multiple entities.

Computer system 500 (e.g., client device(s) 110 and server(s) 130) may include bus 508 or another communication mechanism for communicating information, and a processor 502 (e.g., processors 212) coupled with bus 508 for processing information. By way of example, computer system 500 may be implemented with one or more processors 502. Processor 502 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that may perform calculations or other manipulations of information.

Computer system 500 may include, in addition to hardware, code that creates an execution environment for the computer program in question, e.g., code that constitutes processor firmware, a protocol stack, a database management system, an operating system, or a combination of one or more of them stored in an included memory 504 (e.g., memories 220), such as a Random Access Memory (RAM), a flash memory, a Read-Only Memory (ROM), a Programmable Read-Only Memory (PROM), an Erasable PROM (EPROM), registers, a hard disk, a removable disk, a CD-ROM, a DVD, or any other suitable storage device, coupled to bus 508 for storing information and instructions to be executed by processor 502. Processor 502 and the memory 504 may be supplemented by, or incorporated in, special purpose logic circuitry.

The instructions may be stored in memory 504 and implemented in one or more computer program products, e.g., one or more modules of computer program instructions encoded on a computer-readable medium for execution by, or to control the operation of, computer system 500, and according to any method well-known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 504 may also be used for storing temporary variable or other intermediate information during execution of instructions to be executed by processor 502.

A computer program as discussed herein does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program may be deployed to be executed on one computer or on multiple computers that may be located at one site or distributed across multiple sites and interconnected by a communication network. The processes and logic flows described in this specification may be performed by one or more programmable processors executing one or more computer programs to perform functions by operating on input data and generating output.

Computer system 500 further includes a data storage device 506 such as a magnetic disk or optical disk, coupled to bus 508 for storing information and instructions. Computer system 500 may be coupled via input/output module 510 to various devices. Input/output module 510 may be any input/output module. Exemplary input/output modules 510 include data ports such as Universal Serial Bus (USB) ports. The input/output module 510 may be configured to connect to a communications module 512. Exemplary communications modules 512 (e.g., communications modules 218) include networking interface cards, such as Ethernet cards and modems. In certain aspects, input/output module 510 may be configured to connect to a plurality of devices, such as an input device 514 (e.g., input device 214) and/or an output device 516 (e.g., output device 216). Exemplary input devices 514 include a keyboard and a pointing device, e.g., a mouse or a trackball, by which a user may provide input to computer system 500. Other kinds of input devices 514 may be used to provide for interaction with a user as well, such as a tactile input device, visual input device, audio input device, or brain-computer interface device. For example, feedback provided to the user may be any form of sensory feedback, e.g., visual feedback, auditory feedback, or tactile feedback; and input from the user may be received in any form, including acoustic, speech, tactile, or brain wave input. Exemplary output devices 516 include display devices, such as an LCD (liquid crystal display) monitor, for displaying information to the user.

According to one aspect of the present disclosure, client device(s) 110 and server(s) 130 may be implemented using computer system 500 in response to processor 502 executing one or more sequences of one or more instructions contained in memory 504. Such instructions may be read into memory 504 from another machine-readable medium, such as data storage device 506. Execution of the sequences of instructions contained in memory 504 causes processor 502 to perform the process steps described herein. One or more processors in a multi-processing arrangement may also be employed to execute the sequences of instructions contained in memory 504. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification may be implemented in a computing system that includes a back-end component, e.g., a data server, or that includes a middleware component, e.g., an application server, or that includes a front-end component, e.g., a client computer having a graphical user interface or a Web browser through which a user may interact with an implementation of the subject matter described in this specification, or any combination of one or more such back-end, middleware, or front-end components. The components of the system may be interconnected by any form or medium of digital data communication, e.g., a communication network. The communication network (e.g., network 150) may include, for example, any one or more of a LAN, a WAN, the Internet, and the like. Further, the communication network may include, but is not limited to, for example, any one or more of the following tool topologies, including a bus network, a star network, a ring network, a mesh network, a star-bus network, tree or hierarchical network, or the like. The communications modules may be, for example, modems or Ethernet cards.

Computer system 500 may include clients and servers. A client and server may be generally remote from each other and typically interact through a communication network. The relationship of client and server arises by virtue of computer programs running on the respective computers and having a client-server relationship to each other. Computer system 500 may be, for example, and without limitation, a desktop computer, laptop computer, or tablet computer. Computer system 500 may also be embedded in another device, for example, and without limitation, a mobile telephone, a PDA, a mobile audio player, a Global Positioning System (GPS) receiver, a video game console, and/or a television set top box.

The term “machine-readable storage medium” or “computer-readable medium” as used herein refers to any medium or media that participates in providing instructions to processor 502 for execution. Such a medium may take many forms, including, but not limited to, non-volatile media, volatile media, and transmission media. Non-volatile media include, for example, optical or magnetic disks, such as data storage device 506. Volatile media include dynamic memory, such as memory 504. Transmission media include coaxial cables, copper wire, and fiber optics, including the wires forming bus 508. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer may read. The machine-readable storage medium may be a machine-readable storage device, a machine-readable storage substrate, a memory device, a composition of matter affecting a machine-readable propagated signal, or a combination of one or more of them.

To illustrate the interchangeability of hardware and software, items such as the various illustrative blocks, modules, components, methods, operations, instructions, and algorithms have been described generally in terms of their functionality. Whether such functionality is implemented as hardware, software, or a combination of hardware and software depends upon the particular application and design constraints imposed on the overall system. Skilled artisans may implement the described functionality in varying ways for each particular application.

### General Notes on Terminology

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

To the extent that the term “include,” “have,” or the like is used in the description or the claims, such term is intended to be inclusive in a manner similar to the term “comprise” as “comprise” is interpreted when employed as a transitional word in a claim. The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather “one or more.” All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description. No clause element is to be construed under the provisions of 35 U.S.C. § 112, sixth paragraph, unless the element is expressly recited using the phrase “means for” or, in the case of a method clause, the element is recited using the phrase “step for.”

While this specification contains many specifics, these should not be construed as limitations on the scope of what may be claimed, but rather as descriptions of particular implementations of the subject matter. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

The subject matter of this specification has been described in terms of particular aspects, but other aspects may be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims may be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems may generally be integrated together in a single software product or packaged into multiple software products. Other variations are within the scope of the following claims.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such as an embodiment may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such as a configuration may refer to one or more configurations and vice versa.

In one aspect, unless otherwise stated, all measurements, values, ratings, positions, magnitudes, sizes, and other specifications that are set forth in this specification, including in the clauses that follow, are approximate, not exact. In one aspect, they are intended to have a reasonable range that is consistent with the functions to which they relate and with what is customary in the art to which they pertain. It is understood that some or all steps, operations, or processes may be performed automatically, without the intervention of a user. Method clauses may be provided to present elements of the various steps, operations, or processes in a sample order, and are not meant to be limited to the specific order or hierarchy presented.

Although illustrative embodiments have been shown and described, a wide range of modification, change, and substitution are contemplated in the foregoing disclosure and in some instances, some features of the embodiments may be employed without a corresponding use of other features. Those of ordinary skill in the art would recognize many variations, alternatives, and modifications. Thus, the scope of the invention should be limited only by the following claims, and it is appropriate that the claims be construed broadly and in a manner consistent with the scope of the embodiments disclosed herein.

1. A computer-implemented method, comprising:
training a model to score a priority of a support request based on at least when the support request is initiated and where a device used to initiate the support request is relative to a site associated with a travel booking;
receiving, via a client device associated with a booking of a travel product made in a travel application, a request associated with the booking;
determining a time stamp of the request and a timeframe of the booking;
determining, by a location determination module associated with the travel application, a first geolocation of the client device and a second geolocation of the travel product;
computing, dynamically and in real time, via a geospatial algorithm, a distance of the first geolocation of the client device from the second geolocation of the travel product;
providing, to the trained model, the time stamp of the request, the timeframe of the booking, the first geolocation of the client device, the second geolocation of the travel product, the distance of the first geolocation from the second geolocation, and contextual data including a booking status and an urgency indicator;
determining, by the trained model, a priority level of the request;
updating, dynamically and in real time, based on the priority level of the request, a position of the request in a queue of an agent associated with the travel application; and
routing, based on the updating of the position of the request, the request to the agent.

2. The computer-implemented method of claim 1, further comprising:
identifying a user profile associated with at least one of a first attribute of the request and a second attribute of the client device; and
identifying, based on the user profile, the booking.

3. The computer-implemented method of claim 2, wherein the second attribute includes a telephone number.

4. The computer-implemented method of claim 1, wherein:
the travel product includes at least one of a lodging, a means of transportation, and a destination activity.

5. (canceled)

6. The computer-implemented method of claim 1, wherein determining the priority level of the request includes:
determining the distance of the first geolocation of the client device from the second geolocation of the travel product is greater than a predetermined threshold; and
decreasing, based on determining the distance is greater than the predetermined threshold, the priority level of the request.

7. The computer-implemented method of claim 1, wherein determining the priority level of the request includes:
determining the distance of the first geolocation of the client device from the second geolocation of the travel product is less than or equal to a predetermined threshold; and
increasing, based on determining the distance is less than or equal to the predetermined threshold, the priority level of the request.

8. The computer-implemented method of claim 1, wherein determining the priority level of the request includes:
determining the time stamp of the request is outside a time period before a start time associated with the travel product or after an end time associated with the travel product; and
decreasing, based on determining the time stamp of the request is outside the time period, the priority level of the request.

9. The computer-implemented method of claim 1, wherein determining the priority level of the request includes:
determining the time stamp of the request is within a time period before a start time associated with the travel product, after an end time associated with the travel product, or between the start time and the end time; and
increasing, based on determining the time stamp of the request is within the time period, the priority level of the request.

10. The computer-implemented method of claim 1, wherein the agent is a human agent.

11. A system, comprising:
one or more processors; and
a memory storing instructions that, when executed by the one or more processors, cause the system to perform operations including:
training a model to score a priority of a support request based on at least when the support request is initiated and where a device used to initiate the support request is relative to a site associated with a travel booking;
receiving, via a client device associated with a booking of a travel product made in a travel application, a request associated with the booking;
determining a time stamp of the request and a timeframe of the booking;
determining, by a location determination module associated with the travel application, a first geolocation of the client device and a second geolocation of the travel product;
computing, dynamically and in real time, via a geospatial algorithm, a distance of the first geolocation of the client device from the second geolocation of the travel product;
providing, to the trained model, the time stamp of the request, the timeframe of the booking, the first geolocation of the client device, the second geolocation of the travel product, the distance of the first geolocation from the second geolocation, and contextual data including a booking status and an urgency indicator;
determining, by the trained model, a priority level of the request;
updating, dynamically and in real time, based on the priority level of the request, a position of the request in a queue of an agent associated with the travel application; and
routing, based on the updating of the position of the request, the request to the agent.

12. The system of claim 11, wherein the operations further include:
identifying a user profile associated with at least one of a first attribute of the request and a second attribute of the client device; and
identifying, based on the user profile, the booking.

13. The system of claim 12, wherein the second attribute includes a telephone number.

14. The system of claim 11, wherein:
the travel product includes at least one of a lodging, a means of transportation, and a destination activity.

15. (canceled)

16. The system of claim 11, wherein determining the priority level of the request includes:
determining the distance of the first geolocation of the client device from the second geolocation of the travel product is greater than a predetermined threshold; and
decreasing, based on determining the distance is greater than the predetermined threshold, the priority level of the request.

17. The system of claim 11, wherein determining the priority level of the request includes:
determining the distance of the first geolocation of the client device from the second geolocation of the travel product is less than or equal to a predetermined threshold; and
increasing, based on determining the distance is less than or equal to the predetermined threshold, the priority level of the request.

18. The system of claim 11, wherein determining the priority level of the request includes:
determining the time stamp of the request is outside a time period before a start time associated with the travel product or after an end time associated with the travel product; and
decreasing, based on determining the time stamp of the request is outside the time period, the priority level of the request.

19. The system of claim 11, wherein determining the priority level of the request includes:
determining the time stamp of the request is within a time period before a start time associated with the travel product, after an end time associated with the travel product, or between the start time and the end time; and
increasing, based on determining the time stamp of the request is within the time period, the priority level of the request.

20. A non-transitory computer-readable storage medium storing instructions encoded thereon that, when executed by a processor, cause the processor to perform operations comprising:
training a model to score a priority of a support request based on at least when the support request is initiated and where a device used to initiate the support request is relative to a site associated with a travel booking;
receiving, via a client device associated with a booking of a travel product made in a travel application, a request associated with the booking;
determining a time stamp of the request and a timeframe of the booking;
determining, by a location determination module associated with the travel application, a first geolocation of the client device and a second geolocation of the travel product;
computing, dynamically and in real time, via a geospatial algorithm, a distance of the first geolocation of the client device from the second geolocation of the travel product;
providing, to the trained model, the time stamp of the request, the timeframe of the booking, the first geolocation of the client device, the second geolocation of the travel product, the distance of the first geolocation from the second geolocation, and contextual data including a booking status and an urgency indicator;
determining, by the trained model, a priority level of the request;
updating, dynamically and in real time, based on the priority level of the request, a position of the request in a queue of an agent associated with the travel application; and
routing, based on the updating of the position of the request, the request to the agent.
